(19) United States
(12) Patent Application Publication
(10) Pub. No.: US 2010/0026572 A1
(43) Pub. Date: Feb. 4, 2010

(54) METHOD AND APPARATUS FOR CALCULATING ATTACHMENT LOCATION AND THICKNESS OF SUPPLEMENT PAD USING INDOOR GPS

(75) Inventors: Jin-il Hong, Cheongju-si (KR); Ji-hye Cha, Daejeon (KR); Seong-youb Chung, Gwangju-si (KR); Jae-hoon Kim, Daejeon (KR)

Correspondence Address: HARNESS, DICKEY & PIERCE, P.L.C., P.O. BOX 828, BLOOMFIELD HILLS, MI, 48303, US

(73) Assignee: Samsung Heavy Ind Co. Ltd, Geoje-si Gyeongsangnam-do (KR)

(21) Appl. No.: 12/442,309

(22) PCT Filed: Sep. 20, 2007
(86) PCT No.: PCT/KR2007/004615

§ 371 Date: Mar. 20, 2009

(30) Foreign Application Priority Data
Sep. 21, 2006 (KR) 1020060091804

(51) Int. Cl. G01S 1/00; G01B 21/08

(52) U.S. Cl. 342/357.09

(57) ABSTRACT

A method and apparatus method of calculating attachment location and thickness of a supplement pad to be attached to a member includes a first step of receiving information on flatness measurement points from a unified management server which have previously been calculated during design of the member, a second step of calculating a three-dimensional coordinate at each of the flatness measurement points on the member, and a third step of calculating the attachment location and thickness of the supplement pad to be attached to the member on the basis of the calculated three-dimensional coordinates. The second step includes bringing an indoor GPS sensor into contact with the member at each of the flatness measurement points, and calculating the three-dimensional coordinate on an end of the indoor GPS sensor, which is in contact with the member, through the use of another indoor GPS installed on the member

### TECHNICAL FIELD

The present invention relates to a method and apparatus for calculating attachment location and thickness of a supplement pad to be attached to a member using an indoor GPS. More particularly, the present invention relates to a method and apparatus for calculating attachment location and thickness of a supplement pad to be attached to a member using an indoor GPS, which is capable of measuring flatness of the member precisely and reducing work time.

### BACKGROUND ART

FIG. 1 is a cross-sectional view showing a hull that defines the shape of a ship.

In order to construct a ship, a body that defines the shape of the ship, that is, a hull 100 needs to be first manufactured. In this case, since the hull 100 has a large size, it cannot be manufactured at one time at once. Accordingly, a plurality of pieces are manufactured and then assembled, to thereby manufacture the hull 100. Since the hull 100 is large in size and is provided with curved portions to reduce fluid resistance, it is not completely flat.

A variety of extraneous attachments 104 may be attached to the surface of the hull 100. As described above, however, the shape of the hull 100 is not completely flat. Accordingly, if each extraneous attachment 104 is attached on the hull 100 without being treated, there occurs a space between the attachment 104 and the hull 100, which makes it impossible to stably attach the attachment 104. Therefore, before the attachment 104 is attached on the hull 100, flatness needs to be measured in a depthwise direction of the hull 100, and a supplement pad 102 corresponding to the measured flatness needs to be attached to the break between the hull 100 and the attachment 104. Here, the flatness means a gap H between the lower surface of the supplement pad 102 and the surface of the hull 100.

FIG. 2 is a work flow diagram illustrating a method of calculating attachment location and thickness of a supplement pad according to a prior art.

If information on a flatness detection point is input to a computer 120, a worker 124 carries a document 112, on which the information on the flatness detection point input to the computer is output, and disposes a laser detector 116 at an initial location described in the document 112. Then, the worker 124 installs a rotary laser unit 114 at a predetermined location.

If laser beam is irradiated from the rotary laser unit 114 in all directions at the predetermined location, the laser beam is detected by the laser detector 116, and a three-dimensional coordinate of the hull 100 is calculated at the point where the laser detector 116 is disposed. If it is assumed that a plane parallel to the hull 100 is an X-Y plane, and an axis perpendicular to the X-Y plane is an Z-axis, the three-dimensional coordinate includes the information on the flatness detection point (X and Y coordinates) and information on flatness at the detection location (Z coordinate).

If the flatness detection is completed at the initial location, the worker 124 disposes the laser detector 116 at a next location described in the document 112, on which the information on the flatness detection point is output, while following a route 110 of the flatness detection points, and then repeatedly executes the above-described operation. If the flatness detection is completed at all points described in the document 112, on which the information on the flatness detection point is output, information on detected flatness is output on a document 118, which includes information on flatness detection results.

The information output on the document 118 including the information on the flatness detection results is converted into a format of input data to a calculation program, which is used to calculates the attachment location and the thickness of the supplement pad 126. Then, the converted input data is provided to the computer 120, which has the calculation program therein. At present, computerized files are used as the input data. The computerized files are three-dimensional location data of a portion where the supplement pad 126 is to be attached and take a text format or a DB format.

Subsequently, the attachment location and the thickness of the supplement pad 126 is calculated by the calculation program, and information on the calculation results is output on a document 122, on which information on the attachment location and thickness of the supplement pad is recorded. Then, the worker 124 attaches the supplement pad 126 at a corresponding location while reading the document 122, on which the information on the attachment location and thickness of the supplement pad is recorded.

However, in case where the attachment location and thickness of the supplement pad 126 are calculated by the above-described method, it is difficult to accurately detect the flatness. That is, since the laser detector 116 performs the flatness detection at a 1 mm interval, when the detected flatness has a value smaller than the interval, the flatness cannot be accurately detected.

In addition, a user needs to input the information described in the document 118, on which the information on the flatness detection results is output, as the input data to the calculation program for calculating the attachment location and thickness of the supplement pad 126, that is, as the computerized files. As a result, the work time is made longer.

### DISCLOSURE OF INVENTION

### Technical Problem

Therefore, it is an object of the invention to provide a method and apparatus for calculating attachment location and thickness of a supplement pad using an indoor GPS that can precisely measure flatness, and can reduce a time required to input a flatness detection result as input data, which is used to calculate attachment location and thickness of a supplement pad, thereby reducing a work time.

### Technical Solution

According to an aspect of the invention, there is provided a method of calculating attachment location and thickness of a supplement pad to be attached to a member, which includes: a first step of receiving information on flatness measurement points from a unified management server, the flatness measurement points having previously been calculated during design of the member; a second step of calculating a three-dimensional coordinate at each of the received flatness measurement points on the member; and a third step of calculating attachment location and thickness of the supplement pad to be attached to the member on the basis of the calculated three-dimensional coordinates,

wherein the second step includes bringing an indoor GPS sensor into contact with the member at each of the flatness measurement points, and calculating the three-dimensional coordinate at an end of the indoor GPS sensor, which is in contact with the member, through the use of another indoor GPS installed on the member.

Preferably, the information on the flatness measurement points is received from the unified management server to a hand PC held by a worker.

Preferably, the attachment location and thickness of the supplement pad is calculated by the unified management server which receives the three-dimensional coordinates from the indoor GPS.

Preferably, the information on the attachment location and thickness of the supplement pad is received by a hand PC held by a worker.

According to another aspect of the invention, there is provided an apparatus for calculating attachment location and thickness of a supplement pad to be attached to a member, which includes: a hand PC that is held and provides information on flatness measurement points of the member and information on attachment location and thickness of the supplement pad; a coordinate calculation unit that calculates three-dimensional coordinates on the member at the flatness measurement point provided on the hand PC; and a unified management server that calculates the attachment location and thickness of the supplement pad on the basis of the three-dimensional coordinates from the coordinate calculation unit, and transmits the calculated information and the information on the flatness measurement points to the hand PC,

wherein the coordinate calculation unit includes an indoor GPS sensor that is brought into contact with the member at each of the flatness measurement points, and another indoor GPS that is installed on the member to calculates a three-dimensional coordinate on an end of the indoor GPS sensor which is in contact with the member.

### Advantageous Effects

According to this embodiment, since the indoor GPS capable of precisely calculating the coordinate as compared with the known laser detector is employed, it is possible to accurately calculate the thickness of the supplement pad and to attach the supplement pad having the accurately calculated thickness to the space between the hull and the extraneous attachment.

### BRIEF DESCRIPTION OF THE DRAWINGS

FIG. 1 is a cross-sectional view showing a hull that defines the shape of a ship;

FIG. 2 is a work flow diagram illustrating a method of calculating attachment location and thickness of a supplement pad to be attached to a member, such as a hull of a ship, according to a prior art; and

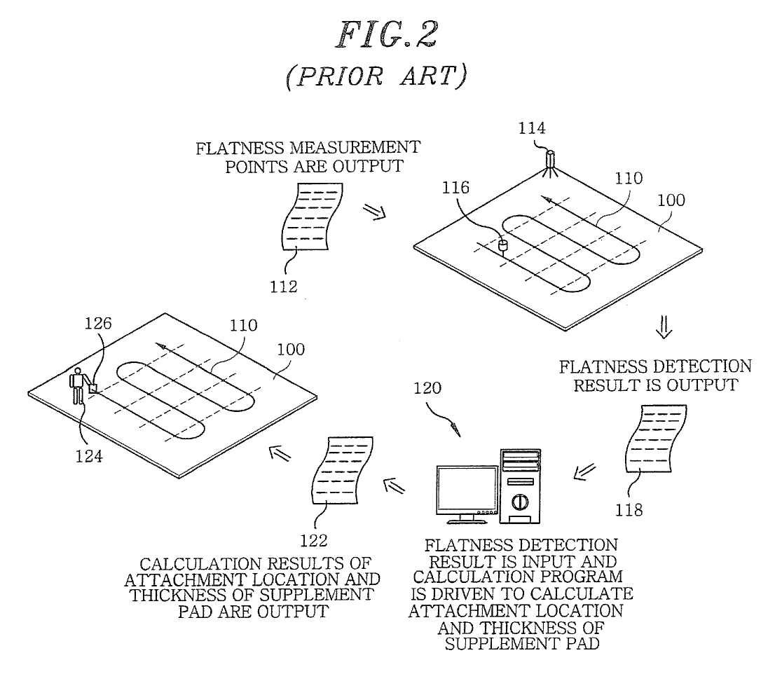

FIG. 3 is a work flow diagram illustrating a method of calculating attachment location and thickness of a supplement pad to be attached to a member, such as a hull of a ship, using an indoor GPS according to an embodiment of the invention.

### BEST MODE FOR CARRYING OUT THE INVENTION

An exemplary embodiment of the invention will now be described in detail with reference to the accompanying drawings.

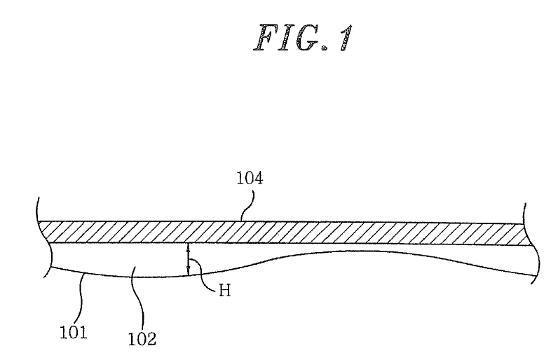

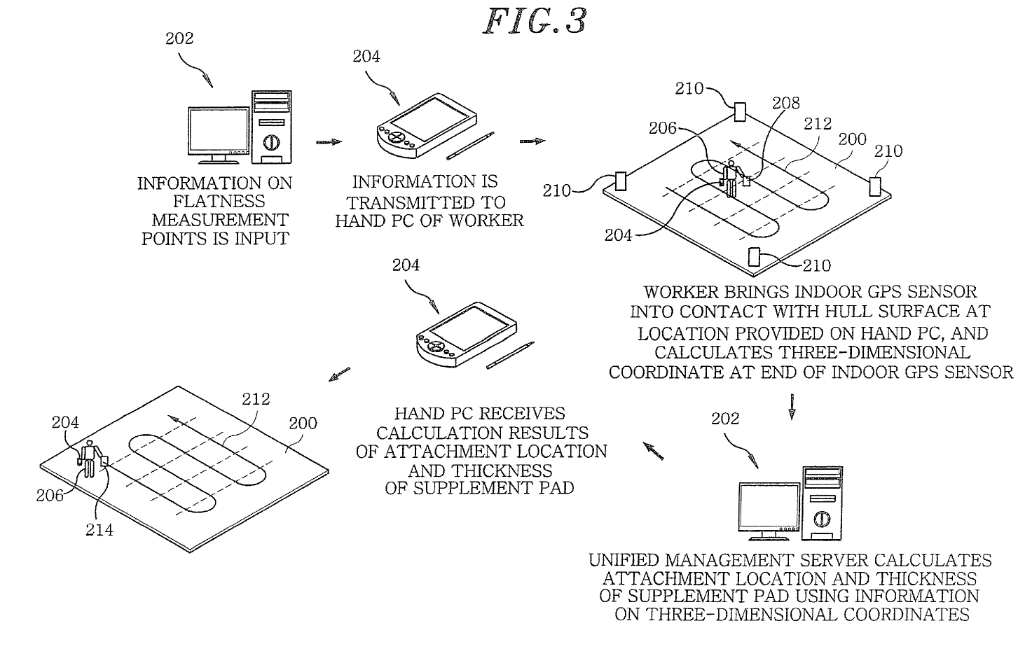

FIG. 3 is a work flow diagram illustrating a method of calculating attachment location and thickness of a supplement pad to be attached to a member, such as a hull of a ship, using an indoor GPS according to an embodiment of the invention. The embodiment includes a first step where information on flatness measurement points, which have been input in advance, is received. The information on the flatness measurement points has been calculated during design of the hull. The information has been input to a unified management server 202 in advance by a user, and is transmitted from the unified management server 202 to a hand PC 204 that a worker 206 holds. The hand PC 204 may be a PDA, a UMPC, or a notebook computer, which has a communication interface for communication with the unified management server 202. Signals between the unified management server 202 and the hand PC 204 may be transmitted in a wired or wireless manner. Here, a term of “flatness” means a gap H between the lower surface of a supplement pad 214 and the surface of a hull 200 (see FIG. 1). The information on the flatness measurement points are two-dimensional coordinates (X and Y coordinates if it is assumed that a plane parallel to the hull 200 is an X-Y plane, and an axis perpendicular to the X-Y plane is a Z axis) of locations on the surface of the hull 200 where the flatness is to be measured.

Next, the embodiment includes a second step where three-dimensional coordinates of the hull 200 at the flatness measurement points received by the hand PC 204 held by the worker 206 are calculated, respectively.

The worker 206 moves an initial flatness measurement point, which is provided on the hand PC 204 as X and Y coordinates, brings an indoor GPS sensor 208 into contact with the surface of the hull 200 at the initial point. Then, the location at an end of the indoor GPS sensor 208, which is in contact with the surface of the hull 200, is detected another indoor GPS 210, which has already been mounted on the hull 200, thereby calculating a three-dimensional coordinate at a flatness measurement point. In this connection, a technology that calculates a relative three-dimensional coordinate of a specific location using an indoor GPS is disclosed in U.S. Pat. No. 6,501,543, the disclosure of which is incorporated herein by reference.

After the three-dimensional coordinate at the initial point is calculated, the worker 206 moves to a next location, which is provided on the hand PC 204, and repeatedly executes the above-described operations while following a route 212 of the flatness measurement points.

Next, the embodiment includes a third step where the attachment location and thickness of the supplement pad 214 to be attached to the hull 200 are calculated on the basis of three-dimensional coordinates obtained at all the flatness measurement points provided on the hand PC 204 at the second step using a calculation program installed in the unified management server 202.

When the three-dimensional coordinates obtained at all of the flatness measurement points provided on the hand PC 204 are calculated at the second step, the information on the three-dimensional coordinates is transmitted to the unified management server 202.

The unified management server 202 has the calculation program installed therein, and the three-dimensional coordinates that are transmitted to the unified management server 202 is used as input data to the calculation program. Computerized files are used as the input data to the calculation program. In this embodiment, the information on the three-dimensional coordinates is directly transmitted to the unified management server 202 in a computerized file format. Accordingly, unlike the prior art, it is not necessary to input the printed three-dimensional coordinates as the computerized files. If the information on the three-dimensional coordinates is transmitted to the unified management server 202, the calculation program is then driven, and the attachment location and thickness of the supplement pad 214 to be attached to the hull 200 are calculated.

Next, the embodiment includes a fourth step where the information on the attachment location and thickness of the supplement pad calculated at the third step is received from the unified management server 202 by the hand PC 204 held by the worker 206.

After that, the unified management server 202 calculates the attachment location and thickness of the supplement pad 214 to be attached to the hull 200, and the result is then transmitted to the hand PC 204 held by the worker 206. Thereafter, the worker 206 attaches the supplement pad 214 having the attachment thickness indicated by the hand PC 204 at the attachment location indicated by the hand PC 204.

While the invention has been shown and described with respect to the embodiments, it will be understood by those skilled in the art that various changes and modifications may be made without departing from the spirit and scope of the invention as defined in the following claims.

1. A method of calculating attachment location and thickness of a supplement pad to be attached to a member, the method comprising:
a first step of receiving information on flatness measurement points from a unified management server, the flatness measurement points having previously been calculated during design of the member;
a second step of calculating a three-dimensional coordinate at each of the received flatness measurement points on the member; and
a third step of calculating attachment location and thickness of the supplement pad to be attached to the member on the basis of the calculated three-dimensional coordinates,
wherein the second step includes bringing an indoor GPS sensor into contact with the member at each of the flatness measurement points, and calculating the three-dimensional coordinate at an end of the indoor GPS sensor, which is in contact with the member, through the use of another indoor GPS installed on the member.

2. The method of claim 1, wherein the information on the flatness measurement points is received from the unified management server to a hand PC held by a worker.

3. The method of claim 1, wherein the attachment location and thickness of the supplement pad is calculated by the unified management server which receives the three-dimensional coordinates from the indoor GPS.

4. The method of claim 1, wherein the information on the attachment location and thickness of the supplement pad is received by a hand PC held by a worker.

5. An apparatus for calculating attachment location and thickness of a supplement pad to be attached to a member using an indoor GPS, the apparatus comprising:
a hand PC that is held and provides information on flatness measurement points of the member and information on attachment location and thickness of the supplement pad;
a coordinate calculation unit that calculates three-dimensional coordinates on the member at the flatness measurement point provided on the hand PC; and
a unified management server that calculates the attachment location and thickness of the supplement pad on the basis of the three-dimensional coordinates from the coordinate calculation unit, and transmits the calculated information and the information on the flatness measurement points to the hand PC,
wherein the coordinate calculation unit includes an indoor GPS sensor that is brought into contact with the member at each of the flatness measurement points, and another indoor GPS that is installed on the member to calculates a three-dimensional coordinate on an end of the indoor GPS sensor which is in contact with the member.
